(19) United States
(12) Patent Application Publication
(10) Pub. No.: US 2026/0274719 A1
(43) Pub. Date: Sep. 17, 2026

(54) ASSEMBLY PROVIDING GRAVITY FED OR PUMP FED CURVILINEAR MOTION FOR POLYMER RELEASE AND MIXING, INCLUDING CENTRALLY MOUNTING MULTI-OUTLET NOZZLE, OVERFLOW RIM DISCHARGE SYSTEM, AND METHOD FOR PASSIVE STORMWATER TREATMENT USING CONTROLLED ROTATIONAL FLOW

(71) Applicants: Gretchen Ming, Elk Grove, CA (US); Peter Ming, Elk Grove, CA (US)

(72) Inventors: Gretchen Ming, Elk Grove, CA (US); Peter Ming, Elk Grove, CA (US)

(21) Appl. No.: 19/669,468

(22) Filed: May 6, 2026

Related U.S. Application Data
(63) Continuation of application No. 18/952,664, filed on Nov. 19, 2024.

(51) Int. Cl. C02F 1/68; B01F 21/20; B01F 25/10; B01F 101/00; C02F 1/56; C02F 103/00

(52) U.S. Cl. CPC C02F 1/688; B01F 21/20; B01F 25/10; C02F 1/56; B01F 2101/305; C02F 2103/001; C02F 2301/026

(57) ABSTRACT

An assembly and method for providing gravity fed or pump fed curvilinear motion for polymer release and mixing is disclosed. The assembly includes a reservoir constructed to promote curvilinear motion of a fluid, a plurality of polymer forms positioned within the reservoir, and an inlet configuration such as a central-mounted multi-outlet nozzle with tangential outlet channels to impart rotational motion. The induced rotation increases friction between the fluid and polymer forms to enhance dissolution and treatment efficiency. The assembly may include an overflow brim at an upper edge of the reservoir and a secondary collection bowl to receive fluid flowing over the brim, establishing consistent residence time and preventing polymer loss. A method is also disclosed comprising pumping stormwater into the reservoir, inducing rotational flow, maintaining polymer-particle interaction for sufficient residence time, and discharging treated stormwater after promoting agglomeration, with optional free floating polymer forms and alternative configurations.

### CROSS-REFERENCE TO RELATED APPLICATIONS

The present application claims priority to U.S. Nonprovisional application Ser. No. 18/952,664 filed Nov. 19, 2024, titled “ASSEMBLY TO PROVIDE GRAVITY FED CURVILINEAR MOTION FOR POLYMER RELEASE AND MIXING,” which is hereby incorporated by reference in its entirety.

### TECHNICAL FIELD

The embodiments disclosed herein generally relate to devices, systems, and methods used for passive or semi-passive water treatment, including systems configured to release, dissolve, or mix polymeric flocculants into stormwater or construction runoff. More particularly, the invention relates to assemblies and methods designed to promote controlled curvilinear and centrifugal fluid motion for improved polymer dissolution, improved sediment disruption, and enhanced water treatment efficiency. The invention further relates to vortex-inducing nozzles, inlet configurations for inducing rotational flow, dual-bowl overflow assemblies, outlet geometries that regulate residence time and prevent premature loss of polymer media, and methods for treating stormwater by inducing rotational flow within a containment volume to promote sustained polymer-particle interaction and flocculation.

### BACKGROUND

Stormwater treatment and sediment control have long been essential components of environmental management, particularly on construction sites and in regions experiencing high rainfall or soil disturbance. Early approaches relied heavily on natural filtration through soil, improvised settling areas, and makeshift containment zones to reduce turbidity. As development intensified and regulatory oversight increased, the need for more predictable and controllable treatment methods became apparent. These early systems often lacked consistency, required extensive land area, and produced widely variable results depending on site conditions.

To address growing water quality concerns, practitioners began implementing passive treatment systems that relied on gravity flow and chemical flocculants to remove suspended solids. Although conceptually simple, many of these systems were limited by the geometry of their containment structures, inconsistent flow patterns, and irregular polymer dissolution rates. Water entering these systems frequently traveled in uneven or partially laminar paths, reducing contact with polymer media and limiting the effectiveness of flocculation. This resulted in treatment inefficiencies, unpredictable residence times, and difficulty meeting modern discharge standards.

As polymer-based treatments evolved, designers introduced polymer blocks, mats, and jute-lined systems intended to create greater surface area and opportunities for sediment capture. However, these methods introduced new challenges, including excessive material waste, difficulty of installation, and lack of repeatability across job sites. Systems relying on large settling basins or baffle arrays were often impractical due to space constraints and high labor requirements. Furthermore, these setups frequently allowed sediment to accumulate in central dead zones where water circulation was weakest.

Semi-passive and partially pumped systems were developed to provide greater control over mixing and flow rate, yet these configurations still depended on external equipment and experienced maintenance issues. Even when pumps delivered water into mixing chambers, the internal flow characteristics were often inadequate to ensure uniform polymer dissolution or sediment suspension. Many systems continued to struggle with polymer loss through outlets, premature discharge of untreated water, and clogging caused by accumulated debris. These shortcomings highlighted the need for a more compact, controllable, and reliable method of inducing effective fluid mixing without relying on complex or powered equipment.

Regulatory developments have further underscored the need for improved passive treatment systems. For example, the California Construction General Permit (CGP) was updated in 2022 to formally allow passive stormwater treatment as a compliance option for construction sites that struggle to meet turbidity limits. Before this update, sites with repeated turbidity exceedances were generally required to install Active Treatment Systems (ATS), which are effective but expensive and complex to operate. The regulatory change was intended to provide a lower-cost alternative to improve compliance. Passive systems generally use anionic polyacrylamide (PAM) as the treatment chemical, which has a lower toxicity profile than chemicals used in ATS (such as chitosan) and is less prone to overdosing. Because of this, passive systems do not require the same level of monitoring and automation. The CGP allows pumps to move water within a passive treatment setup but generally discourages automated chemical dosing systems.

Anionic PAM is available in several forms, including liquid, granular, and solid block. Liquid PAM requires controlled injection and monitoring. Granular PAM disperses quickly and is difficult to control in flowing water. Solid block polymer dissolves gradually and is commonly used in passive treatment. Systems using solid block polymer allow continuous treatment without injection equipment and align with passive system requirements. However, existing passive approaches using solid block polymer, particularly in-channel systems where polymer blocks are placed directly in flowing water with turbulence elements and downstream capture materials, often do not reliably meet turbidity requirements due to flow variability and dosing inconsistency, limited mixing, uncontrolled contact time, and overall performance variability.

Many existing passive systems hold polymer in fixed positions, such as anchored to the ground, mounted on poles, or contained in mesh bags. These approaches create additional issues including uneven exposure to flowing water, clogging of mesh or containment structures, bypass of untreated water, and frequent manual replacement. These limitations motivated the development of systems where polymer could remain freely mobile within the treatment volume instead of being fixed in place.

Modern stormwater treatment demands solutions that combine the reliability of engineered fluid motion with the simplicity and accessibility of passive systems. A growing emphasis on portability, reduced labor, and sustained treatment performance has motivated the development of new geometries, new mixing mechanisms, and new ways of managing polymer media within confined vessels. The technical field continues to evolve toward systems that maintain high treatment efficiency while operating autonomously under variable flow conditions. There is a need for a method that controls the hydraulic environment so that polymer remains mobile and interacts with suspended particles long enough to promote flocculation, regardless of the specific physical hardware configuration used to achieve such conditions.

### SUMMARY OF THE INVENTION

This summary is provided to introduce a variety of concepts in a simplified form that is further disclosed in the detailed description of the embodiments. This summary is not intended for determining the scope of the claimed subject matter.

The present invention provides an assembly for providing gravity fed or pump fed curvilinear motion for polymer release and mixing that improves the treatment of fluid by controlling how the fluid moves within a reservoir. The assembly includes a reservoir constructed to promote curvilinear motion to a fluid, enabling the fluid to travel along an interior wall in a spiraling path. A plurality of polymer forms composed of a polymer are positioned within the reservoir so that the fluid flows around the plurality of polymer forms and causes discharge of the polymer into the fluid. The curvilinear motion created within the reservoir increases friction between the fluid and the plurality of polymer forms, allowing enhanced polymer dissolution and improved treatment results. The system is designed to operate in a gravity fed or pump fed manner, which enables passive or semi-passive treatment without reliance on complex mechanical equipment. In pump fed embodiments, a pump is used to move water into the reservoir at a controlled flow rate independent of rainfall intensity, thereby allowing control of residence time and mixing conditions.

Another aspect of the invention includes a central-mounted multi-outlet nozzle positioned within the reservoir to induce a controlled rotational flow pattern. The central-mounted multi-outlet nozzle includes a hose barb inlet configured to receive incoming fluid into the nozzle. The central-mounted multi-outlet nozzle further includes a plurality of tangential outlet channels arranged around a lower perimeter of the nozzle. Each tangential outlet channel is oriented to direct the fluid circumferentially along an interior wall of the reservoir. The tangential outlet channels increase rotational motion within the reservoir, which improves the rate of discharge of the polymer into the fluid.

In alternative embodiments, the assembly may include inlet configurations other than a central-mounted multi-outlet nozzle to induce rotational flow. For example, rotational flow may be induced using one or more off-center inlets, one or more side-mounted inlets, multiple distributed inlets positioned at various locations around the reservoir, or peripheral inlets oriented to direct fluid tangentially along the reservoir wall. The inlet configuration is not limited to any specific number, position, or geometry of inlets, provided that the inlet configuration introduces fluid into the reservoir in a manner that induces sustained rotational flow. These alternative inlet configurations may achieve hydraulic behavior similar to the central-mounted multi-outlet nozzle while using different structural arrangements.

The assembly employing the central-mounted multi-outlet nozzle enhances the efficiency of polymer release by eliminating stagnant regions within the reservoir. The tangential outlet channels impart rotational velocity to the fluid, allowing the fluid to continuously circulate throughout the reservoir. This circulation improves contact between the fluid and the plurality of polymer forms positioned within the reservoir. The rotational motion disrupts sediment accumulation at the center of the reservoir by generating spiral flow originating at a central position. This coordinated flow pattern results in more consistent mixing and improved treatment performance.

Through testing, it has been observed that inducing sustained rotational flow significantly improves polymer-particle interaction compared to straight-through flow. Continuous circulation increases mixing, maintains polymer exposure, and promotes floc formation. Introducing flow near the lower region of the reservoir and directing it outward helps reduce sediment buildup on the bottom of the reservoir, keeping the mixing environment consistent over time. This bottom-cleaning effect is achieved by the continuous sweeping of the lower region of the reservoir by the directed flow, which prevents the formation of stagnant zones and reduces fouling. The concept is not limited to a specific number of inlets but rather to the creation of a flow field that both maintains circulation and mitigates sediment buildup.

The reservoir may operate with free floating polymer forms to further enhance fluid and polymer interaction. The free floating polymer forms remain mobile within the rotational motion produced by the tangential outlet channels or other inlet configurations. This mobility allows the polymer forms to circulate throughout the reservoir and encounter turbulent flow regions created by the inlet. The free floating polymer forms therefore experience increased frictional forces generated by the curvilinear motion of the fluid. These interactions contribute to improved polymer dissolution and improved turbidity reduction.

13. In other embodiments, the plurality of polymer forms may be positioned within a container to increase exposure time between the polymer and the fluid. The container may be configured to permit fluid flow while retaining the polymer forms in a defined region within the reservoir. The container assists in directing the polymer forms into areas of increased rotational motion created by the central-mounted multi-outlet nozzle or other inlet configuration. This interaction enhances polymer release efficiency by ensuring consistent flow over and around the polymer forms. The container can be modified to accommodate various sizes, shapes, or configurations of polymer forms.

The central-mounted multi-outlet nozzle may include an internal flow divider configured to divide incoming fluid into the plurality of tangential outlet channels. This flow division produces multiple smaller jets exiting the nozzle to create a uniform circumferential discharge pattern. The internal structure assists in balancing flow among the tangential outlet channels to avoid uneven mixing. The compact shape of the nozzle allows placement at or near a geometric center of the reservoir floor. This placement maximizes the rotational motion created within the reservoir and improves overall mixing performance.

Another embodiment of the invention includes an overflow brim positioned at an upper edge of the reservoir to control the fluid outlet. The overflow brim allows fluid to exit the reservoir only after the fluid reaches a predetermined fill height. As fluid flows over the overflow brim, it forms a uniform thin sheet that minimizes downward suction forces that could affect the plurality of polymer forms. This overflow geometry ensures that the polymer forms remain within the reservoir instead of being removed during outflow. The overflow brim establishes a consistent residence time that supports complete polymer dissolution and full fluid treatment.

In alternative embodiments, the outlet of the reservoir may be configured differently from an overflow brim. For example, the outlet may comprise a pipe outlet positioned near the top of the reservoir, surrounded by a perforated cage. The perforations allow water to exit while mechanically preventing polymer blocks from being drawn out. This approach does not require a secondary collection bowl because the flow is already directed through the pipe. The perforation pattern and cage geometry can be optimized to balance residence time, outlet flow rate, and polymer containment without introducing clogging or excessive backpressure. Alternative outlet configurations may include bottom drains, slot weirs, peripheral outlet holes, or other structures configured to discharge treated fluid while selectively retaining polymer forms within the reservoir.

The system is designed so that treated stormwater and agglomerated particles are discharged while the solid polymer blocks remain within the reservoir. This allows the polymer to continue functioning without frequent replacement and avoids downstream release of polymer material. In some embodiments, this selective discharge is achieved by allowing water to overflow the upper edge of the reservoir in a thin sheet, which does not carry the larger polymer blocks out of the mixing volume. The key concept is selective discharge of treated water while retaining the polymer within the treatment zone, regardless of the specific outlet configuration used.

The assembly may also include a secondary collection bowl positioned below the reservoir to receive fluid flowing over the overflow brim. The secondary collection bowl stabilizes the outflow by reducing surging that might occur during overflow events. The secondary collection bowl directs fluid toward a discharge path for removal from the system. This additional structure helps maintain consistent hydraulic behavior throughout the treatment process. The combination of the reservoir and the secondary collection bowl forms a dual bowl assembly that enhances passive treatment performance.

The dual bowl assembly provides a compact and modular configuration for controlling the movement of treated fluid. The reservoir establishes rotational flow for mixing and polymer dissolution, while the secondary collection bowl receives and channels the treated fluid. This dual bowl assembly helps prevent clogging by encouraging smooth hydraulic transitions between the two bowls. The design supports passive flow without requiring pumps or active flow controls within the treatment unit. The bowl assembly is adaptable to a variety of field conditions and treatment requirements.

In another embodiment, a perforated cage outlet may be positioned near the overflow brim to prevent removal of the plurality of polymer forms. The perforated cage outlet allows fluid to pass while blocking larger polymer pieces from escaping the reservoir. This passive retention structure enables more consistent polymer dosing by retaining polymer forms for their full operational lifespan. The perforated cage outlet also helps prevent clogging of downstream discharge components. This feature enhances reliability in environments with variable flow rates and sediment concentrations.

The rotational motion created by the central-mounted multi-outlet nozzle or other inlet configuration provides additional treatment advantages beyond polymer dissolution. As the tangential outlet channels or other inlets direct fluid circumferentially, sediment is lifted and suspended within the fluid column. This suspended state increases opportunities for sediment to contact the polymer forming the plurality of polymer forms. The improved frequency of collisions enhances floc formation and sediment removal. This mixing effect helps reduce turbidity more effectively than systems relying solely on gravitational settling.

The overflow brim of the assembly ensures that fluid leaves the reservoir only after receiving sufficient treatment. Because the brim spans a wide surface area, the outflow velocity remains low and reduces turbulence near the surface of the fluid. This controlled overflow protects the plurality of polymer forms from being unintentionally removed from the reservoir. The overflow also minimizes disturbance to the curvilinear motion occurring within the reservoir. This structure provides predictable fluid management for consistent treatment results.

The secondary collection bowl further contributes to treatment reliability under variable flow conditions. As fluid enters the secondary collection bowl, it is guided toward a discharge pipe or other downstream component. The secondary collection bowl absorbs higher flow rates without compromising the uniform overflow pattern created at the overflow brim. This added stabilizing region supports continued passive operation without mechanical intervention. The bowl improves the handling of treated fluid in environments where inflow volumes may fluctuate widely.

The assembly for providing gravity fed or pump fed curvilinear motion for polymer release and mixing may be manufactured using a variety of materials suited for stormwater or industrial environments. The reservoir, central-mounted multi-outlet nozzle or alternative inlet configuration, overflow brim, and secondary collection bowl may be formed using molded plastics, composites, or other durable materials. These components may be integrated or assembled depending on field requirements. The design accommodates scaling for small temporary installations or large permanent treatment systems. The modular nature of the assembly facilitates replacement or upgrade of individual components.

The method for treating stormwater using gravity fed or pump fed curvilinear motion for polymer release and mixing further supports use of these structural features. The method includes directing stormwater into the reservoir, positioning the plurality of polymer forms within the reservoir, and introducing stormwater using the central-mounted multi-outlet nozzle or other inlet configuration. The method then includes allowing the treated stormwater to rise within the reservoir until flowing over the overflow brim or exiting through an alternative outlet. The overflowed stormwater may then be received in the secondary collection bowl or directed to another downstream component. The method improves polymer dissolution by increasing friction between stormwater and the plurality of polymer forms.

In a broader aspect, the method for treating stormwater comprises pumping stormwater into a reservoir, introducing the pumped stormwater into the reservoir in a manner that induces rotational flow of the stormwater within the reservoir, positioning a plurality of polymer forms within the reservoir such that the curvilinear motion causes disintegration of the plurality of polymer forms into the stormwater, maintaining interaction between the rotating stormwater and the plurality of polymer forms for a residence time sufficient to increase agglomeration of suspended particles within the stormwater, and discharging stormwater from the reservoir after promoting agglomeration of suspended particles. This broader method protects the functional treatment process regardless of the specific hardware layout, inlet configuration, or outlet geometry used. The core operating principle is controlling the hydraulic environment so that polymer remains mobile and interacts with suspended particles long enough to promote flocculation.

The residence time within the reservoir may be controlled by adjusting the pump flow rate, the reservoir volume, or the outlet configuration. Using a pump to introduce stormwater allows the flow rate to be controlled independently of rainfall intensity, providing consistent mixing and dosing conditions regardless of weather. The reservoir size and inflow rate together determine the residence time, which can be adjusted to suit site-specific treatment requirements. Treated water exiting the reservoir is then directed to downstream settling or filtration measures.

Overall, the invention provides a passive or semi-passive, gravity or pump driven system capable of improving polymer dissolution, sediment suspension, and turbidity reduction in stormwater treatment applications. The combination of the central-mounted multi-outlet nozzle or alternative inlet configuration, the plurality of tangential outlet channels or other directed flow paths, the overflow brim or alternative outlet configuration, and optionally the secondary collection bowl creates a controlled and efficient treatment environment. Each component contributes to enhanced curvilinear motion, improved retention of polymer media, and consistent outflow management. The structure and method support compliance with treatment performance goals across varied operating conditions. The invention therefore addresses longstanding challenges in passive and semi-passive stormwater treatment systems.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the assembly for providing gravity fed curvilinear motion for polymer release and mixing for the purposes of treating water, according to some embodiments;

FIG. 2 illustrates a perspective view of the assembly for providing gravity fed curvilinear motion for polymer release and mixing for the purposes of treating water, according to some embodiments;

FIG. 3 illustrates a perspective view of the bottom of the reservoir including the outlet, according to some embodiments;

FIG. 4 is a perspective view of the central-mounted multi-outlet nozzle illustrating the arrangement of the hose inlet, nozzle body, internal flow divider, and tangential outlet channels, according to some embodiments;

FIG. 5 is an alternative perspective view of the central-mounted multi-outlet nozzle showing the tangential outlet channel orientation relative to the reservoir floor, according to some embodiments;

FIG. 6 is an exploded view of the dual bowl assembly showing the reservoir, overflow brim, secondary collection bowl, and nozzle interface prior to assembly, according to some embodiments;

FIG. 7 is a perspective view of the assembled dual bowl assembly illustrating the relationship between the reservoir, overflow brim, secondary collection bowl, and discharge path, according to some embodiments;

FIG. 8 is a cross-sectional view of the dual bowl assembly illustrating the internal fluid flow path through the reservoir, the central-mounted multi-outlet nozzle, the overflow brim, and the secondary collection bowl, according to some embodiments;

FIGS. 9A and 9B are view of the central-mounted multi-outlet nozzle showing the tangential outlet channel orientation, according to some embodiments;

FIGS. 10A and 10B illustrate views of the assembly for providing gravity fed curvilinear motion for polymer release and mixing for the purposes of treating water, according to some embodiments;

FIG. 10C is cross-sectional view of the central-mounted multi-outlet nozzle, according to some embodiments; and

FIGS. 11A and 11B illustrate views of the assembly for providing gravity fed curvilinear motion for polymer release and mixing for the purposes of treating water, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an assembly for providing gravity fed or pump fed curvilinear motion for polymer release and mixing which is used to efficiently treat water, such as runoff from a construction site or in environments which can receive high turbidity water. The assembly includes fluid inputs which receive the turbid fluid and direct the flow of the fluid into a reservoir constructed to promote curvilinear motion of the fluid. Polymer forms are positioned within the reservoir and the fluid flows around the polymer forms, causing the discharge of the polymer into the fluid. The curvilinear motion of the fluid increases the rate of discharge of the polymer to result in the treatment of the fluid. In some embodiments, the fluid is introduced into the reservoir using a pump, allowing flow rate to be controlled independently of rainfall intensity.

The configuration of the reservoir is such that it promotes the curvilinear motion of the fluid. This is beneficial in increasing friction between the fluid and the polymer forms, causing an increase in the rate at which the polymer is discharged (i.e., disintegration) into the fluid, and thus increases the efficiency of the water treatment process. The curvilinear motion of the fluid also promotes the mixing of fluid in a condensed area.

The assembly is designed to allow for the fluid to enter at a high velocity and move along the curve of the bowl, coming in contact with polymer that is positioned in the flow of water. The continued motion along the landscape of the reservoir allows for the water to then mix and collide with other particles to promote the flocculation of sediment in the water.

The preliminary tests showed an 81% reduction of turbidity in the water after passing through the prototype and a 95% reduction when the water was passed over jute, whereas the standard method only had a 49% reduction and 58.6% reduction in turbidity.

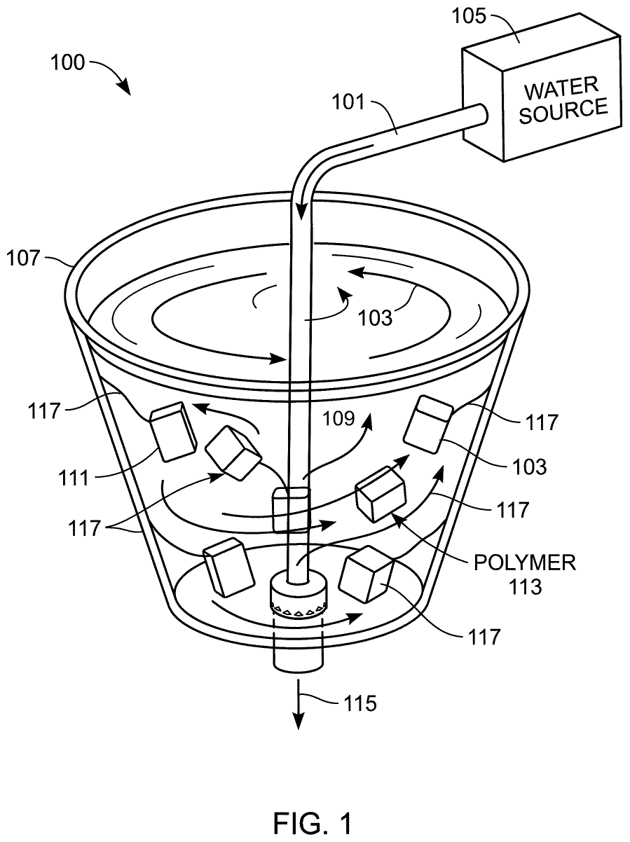

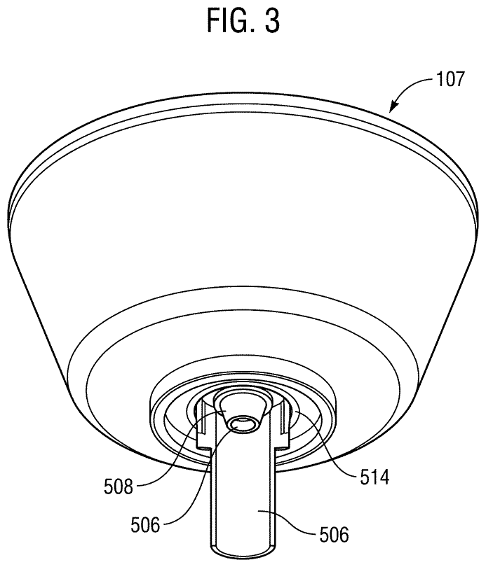

FIG. 1 illustrates the assembly 100 which provides gravity fed curvilinear motion for polymer release and mixing for the purposes of treating a turbid fluid (i.e., construction water runoff, stormwater runoff, etc.). One or more fluid inputs 101 collect fluid 103 from a water source 105 and direct the flow of the fluid into a reservoir 107. The reservoir 107 is shaped to provide curvilinear motion to the fluid 103 once it enters the interior of the reservoir 107. The reservoir 107 is constructed having a conical, frustoconical or similar shape such that the fluid enters the interior 109 and begins moving in a curvilinear motion. A plurality of polymer forms 111 are comprised of a polymer 113 and are positioned within the reservoir 107. This allows the fluid 103 to contact the polymer forms 111 thus causing the polymer 113 to disintegrate. In such, the polymer acts as a flocculant to treat the fluid before it exits through an outlet 115. In such, the fluid exiting the outlet 115 (also see FIG. 3) is treated. Each polymer form 111 may be connected to the reservoir 107 which holds the polymer forms 111 within the reservoir 107. A container 119 is positioned within the reservoir 107 to increase the exposure time between the fluid 103 and the polymer forms 111.

In some embodiments, the fluid inputs 101 are designed to direct the flow of the fluid 103 at a sufficient velocity to cause the fluid to flow in a curvilinear motion. In such, the system operates without the need for external power sources by utilizing the force of gravity to drive the flow of the fluid 103.

In some embodiments, a pump may be included to forcibly direct the flow of the fluid into the fluid inputs 101. The pump may be advantageous if gravity is insufficient in moving the fluid 103 at a rate necessary for causing curvilinear motion within the reservoir 107. The use of a pump allows the flow rate to be controlled independently of rainfall intensity, thereby enabling consistent mixing and dosing conditions. The reservoir size and inflow rate together determine residence time, which can be adjusted by changing pump flow rate. The use of a pump within a passive treatment system is permitted under applicable regulatory frameworks and does not convert the system to an active treatment system, provided that automated chemical dosing is not employed.

In some embodiments, the polymer 113 may be any polymer known in the arts which acts as a flocculant. The polymer 113 may be a long negatively charged molecule which binds to soil and other contaminants within the water. In preferred embodiments, the polymer 113 is an anionic polyacrylamide (PAM) in solid block form. Solid block polymer dissolves gradually and is commonly used in passive treatment because it allows continuous treatment without injection equipment.

In some embodiments, the polymer 113 may be configured as a polymer mat or another similar form which enables the polymer 113 to dissolve, disintegrate, or otherwise diffuse into the fluid.

In some embodiments, the reservoir 107 is beneficial by increasing the contact time between the turbid fluid and the polymer, thus increasing the efficiency of the polymer and its ability to treat the fluid prior to its egress through the output. The curvilinear motion increases the likelihood of the polymer colliding with sediment particles within the turbid water.

The assembly 100 described herein provides a portable, cost-efficient, compact, and efficient means of treating turbid fluid. The assembly is simple to use and does not require external power sources in gravity fed embodiments, which may be inefficient, costly, and/or unfeasible in some applications and locations. In pump fed embodiments, the assembly requires only a pump to move water and does not require automated chemical dosing or complex monitoring systems.

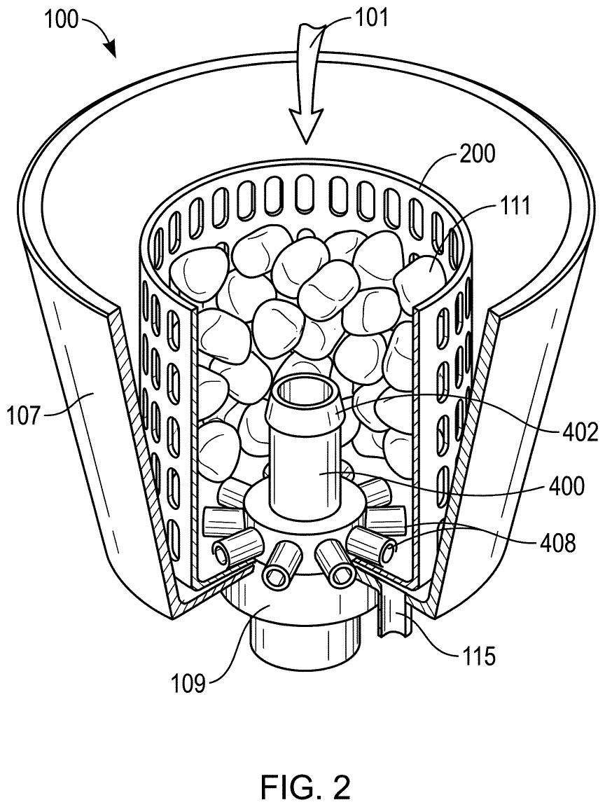

To maintain the polymer forms 111 within the reservoir 107 various means may be used including a tether 117 (as shown in FIG. 1) or an enclosure 200 (as is shown in FIG. 2). The polymer forms 111 may also simply be free floating within the reservoir 107 or may be retained therein using other methods of attaching the polymer to the reservoir 107. In the specific example illustrated in FIG. 2, the enclosure 200 is a cage-type structure which allows water to flow through the openings, while retaining the polymer forms 111 within the reservoir 107 by preventing the large polymer 113 pieces from exiting the enclosure 200. In preferred embodiments, the polymer forms 111 are free floating within the reservoir, allowing the polymer forms to circulate within the rotational flow field and maintain continuous interaction with the circulating water.

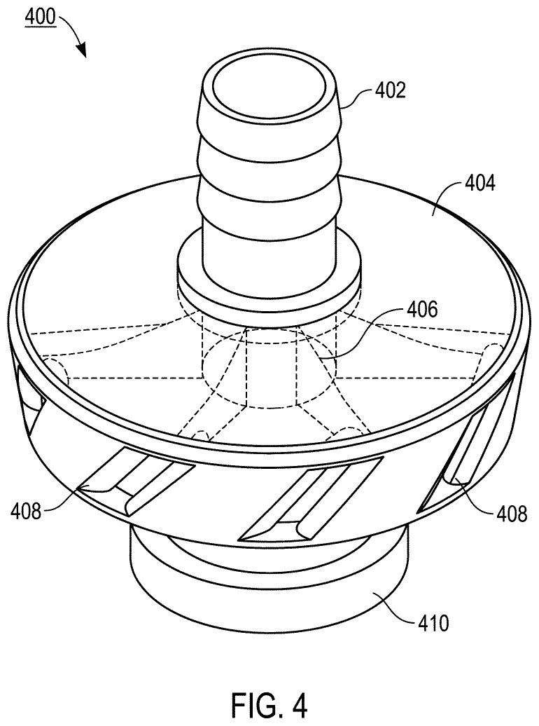

FIG. 4 illustrates a perspective view of a central-mounted multi-outlet nozzle 400 configured for installation within a reservoir 107 constructed to promote curvilinear motion of a fluid 103. The central-mounted multi-outlet nozzle 400 includes a inlet 402 positioned at an upper portion of the nozzle to receive fluid entering the reservoir, whether from a gravity-fed supply, a pump, or another fluid input 101. The nozzle further includes a nozzle body 404 that encloses an internal passage configured to distribute fluid to multiple subchannels. Within the nozzle body 404, an internal flow divider 406 separates incoming fluid into a plurality of distributed flow paths. These flow paths terminate in a plurality of tangential outlet channels 408, each oriented tangentially relative to the interior wall of the reservoir 107.

In some embodiments, the nozzle may include a hose barb (as is illustrated) or threading to attach the hose to the nozzle.

The tangential outlet channels 408 are arranged around a lower perimeter of the nozzle body 404 and are configured to direct fluid circumferentially along the reservoir interior 109, thereby inducing rotational motion. The tangential geometry of the outlet channels 408 produces a spiraling flow field that begins at or near the reservoir floor and expands upward toward the overflow region. This rotational motion enhances frictional interaction between the fluid 103 and the plurality of polymer forms 111 positioned within the reservoir. The central-mounted multi-outlet nozzle 400 is supported by a nozzle base 410, which provides mechanical engagement with the reservoir floor or a mounting port. This configuration enables repeatable and passive induction of rotational flow and prevents the formation of dead zones associated with sediment buildup.

The configuration of the tangential outlet channels 408 serves two functional purposes. First, it promotes sustained rotational circulation, reducing the formation of stagnant zones within the treatment volume. Second, it helps prevent sediment accumulation along the bottom surface by continuously sweeping the lower region of the reservoir. These effects contribute to consistent mixing performance and reduce fouling over time. The present design uses multiple outlets (in the illustrated embodiment, four), although similar hydraulic behavior could be achieved with a different number of outlets. The concept is not limited to a specific number of outlets but rather to the creation of a flow field that both maintains circulation and mitigates sediment buildup.

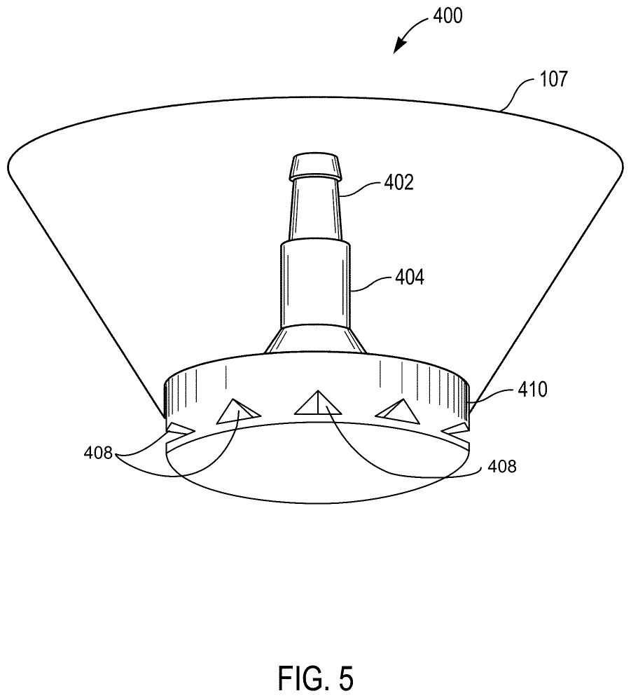

FIG. 5 illustrates an alternative perspective view of the central-mounted multi-outlet nozzle 400, further demonstrating the orientation of the tangential outlet channels 408 relative to the reservoir floor. In this view, the inlet 402 is shown extending upward to receive fluid into the internal flow divider 406 located within the nozzle body 404. The tangential outlet channels 408 are directed outward and downward from the lower portion of the nozzle body 404 to impart rotational velocity to the fluid as it enters the reservoir 107. The angular positioning of the tangential outlet channels 408 ensures that fluid is directed circumferentially around the interior 109 of the reservoir, maintaining consistent rotational flow under varying hydraulic conditions. The nozzle base 410 provides sealing and structural stability so that the nozzle remains centered during operation.

This alternative view illustrates that the central-mounted multi-outlet nozzle 400 may be produced with varying exterior geometries to optimize manufacturing or fluid dynamics. The nozzle body 404 may include tapered or stepped outer surfaces to reduce turbulence or improve flow uniformity. Additional reinforcement features may be integrated into the body 404 or nozzle base 410 to withstand prolonged hydraulic loading. The internal flow divider 406 may be configured to proportion incoming fluid evenly among the tangential outlet channels 408 to prevent imbalanced flow conditions. FIG. 5 therefore demonstrates that the nozzle may be adapted to numerous reservoir geometries while maintaining its essential function of producing rotational motion within the fluid.

It should be understood that the central-mounted multi-outlet nozzle 400 is one illustrative embodiment of an inlet configuration that induces rotational flow within the reservoir. Similar hydraulic behavior could be achieved using alternative inlet configurations, such as off-center inlets, side-mounted inlets, multiple distributed inlets, peripheral inlets, or other inlet geometries oriented to direct fluid tangentially or circumferentially within the reservoir. The reservoir may also have shapes other than conical or frustoconical, including cylindrical, rectangular, polygonal, or other geometries, provided that the inlet configuration is capable of inducing rotational flow within the reservoir. The invention is not limited to any specific inlet location, inlet number, inlet geometry, or reservoir shape.

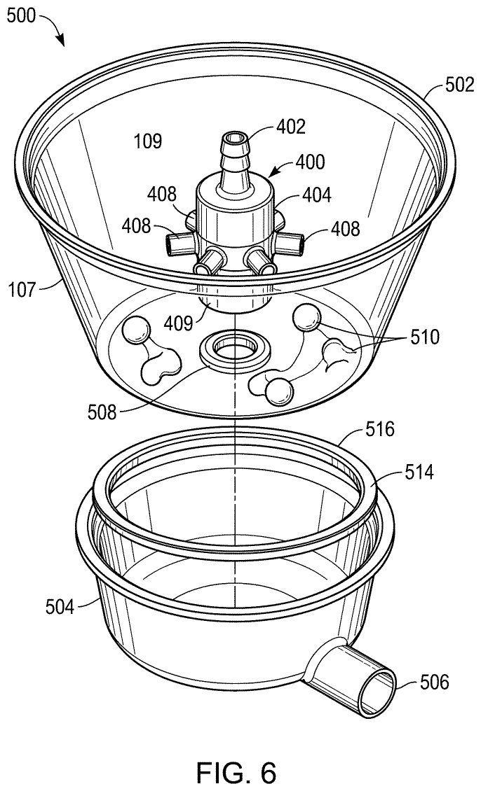

FIG. 6 illustrates an exploded view of a dual bowl assembly 500 that includes a reservoir 107, an overflow brim 502, and a secondary collection bowl 504. The reservoir 107 is constructed to promote curvilinear motion of the fluid 103, and the overflow brim 502 is located at an upper edge of the reservoir to function as a passive outlet. The overflow brim 502 allows fluid to exit the reservoir only after the fluid reaches a predetermined fill height, thereby establishing a consistent residence time for treatment. Beneath the reservoir, the secondary collection bowl 504 is positioned to receive fluid flowing over the overflow brim 502 and to guide the fluid into a discharge path 506 for removal from the system. The exploded configuration illustrates the mechanical relationship among these components prior to full assembly.

The central-mounted multi-outlet nozzle 400 is shown positioned beneath the reservoir 107, aligned with a nozzle interface 508 formed in the reservoir floor. This interface enables secure placement of the nozzle body 404 within the interior 109 of the reservoir to ensure effective rotational flow generation. The plurality of polymer forms 111 or, in some embodiments, free floating polymer forms 510, may be positioned within the reservoir before assembly to maximize exposure to the curvilinear motion created by the tangential outlet channels 408. The secondary collection bowl 504 includes a structural bowl mounting interface 514 that aligns with a corresponding surface 516 on the reservoir to produce a sealed or semi-sealed connection. This assembly enables passive, stable operation even under fluctuating flow volumes.

FIG. 6 may also depict an optional perforated cage outlet 512 that can be installed at or near the overflow brim 502 in alternative embodiments. The perforated cage outlet 512 allows fluid to exit the reservoir while preventing removal of polymer forms 111 or 510. The exploded view highlights the modularity of the dual bowl assembly 500, demonstrating that components may be interchanged or replaced to meet site-specific requirements. This modular design allows the treatment unit to be transported, serviced, or scaled with minimal disruption. The arrangement of parts in FIG. 6 is illustrative of assembly sequence and does not limit alternative manufacturing methods. In alternative embodiments, the secondary collection bowl 504 may be omitted. In such embodiments, the reservoir 107 may be used alone with an overflow brim 502 or with an alternative outlet configuration, such as a pipe outlet surrounded by a perforated cage positioned near the top of the reservoir. The treated water exits through the alternative outlet and is directed to downstream settling or filtration measures without the need for a secondary collection bowl. The invention is not limited to embodiments that include a secondary collection bowl.

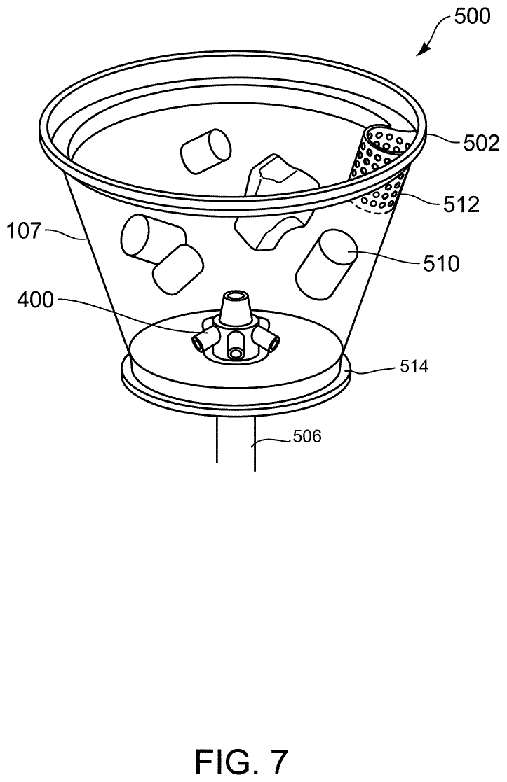

FIG. 7 illustrates a perspective view of the fully assembled dual bowl assembly 500, including the reservoir 107, the overflow brim 502, and the secondary collection bowl 504. In the assembled configuration, the reservoir 107 defines the primary mixing zone where rotational motion induced by the central-mounted multi-outlet nozzle 400 interacts with the plurality of polymer forms 111 or free floating polymer forms 510. The overflow brim 502 forms an uninterrupted perimeter that allows fluid to exit the reservoir in a thin, uniform sheet that minimizes suction forces acting upon the polymer forms. The secondary collection bowl 504 captures this overflow and gently directs the fluid toward the discharge path 506 without disturbing the curvilinear motion above. The structure ensures consistent residence time and prevents premature discharge of inadequately treated fluid.

The bowl mounting interface 514 provides structural stability and alignment between the reservoir 107 and the secondary collection bowl 504, enabling long-term passive operation. The discharge path 506 may include a pipe, conduit, or outlet port configured to convey treated fluid downstream for further handling. In certain embodiments, the perforated cage outlet 512 may be integrated into the region surrounding the overflow brim 502 to prevent polymer loss while allowing fluid passage. The assembled perspective in FIG. 7 demonstrates the compact and efficient configuration of the dual bowl assembly 500, which may be manufactured as a single integrated component or as multiple detachable components. The simplicity and passive nature of this assembly make it suitable for scalable deployment across a wide range of treatment environments.

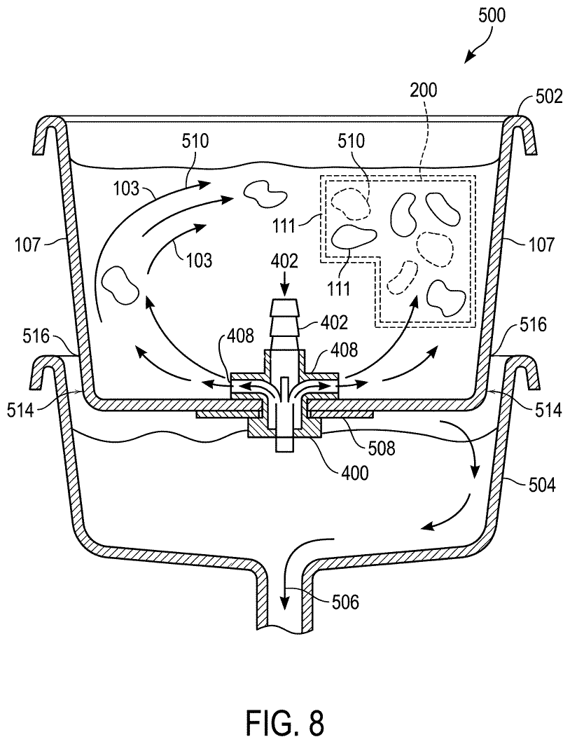

FIG. 8 illustrates a cross-sectional view of the dual bowl assembly 500, depicting the internal fluid flow path and structural relationships among the reservoir 107, the central-mounted multi-outlet nozzle 400, the overflow brim 502, and the secondary collection bowl 504. In this cross-sectional view, fluid 103 enters the system through the inlet 402 of the central-mounted multi-outlet nozzle 400 and is distributed through the tangential outlet channels 408 into the interior 109 of the reservoir 107. The tangential outlet channels 408 direct the fluid 103 laterally and circumferentially along the interior wall of the reservoir 107, inducing the curvilinear rotational motion described above. As the fluid spirals upward within the reservoir 107, it contacts the plurality of polymer forms 111 retained within the enclosure 200, as well as any free floating polymer forms 510 moving within the rotational flow field. The cross-sectional view reveals how the nozzle shaft 508 extends through the floor of the reservoir 107 and is secured at the bowl mounting interface 514, which provides mechanical engagement and sealing between the reservoir 107 and the secondary collection bowl 504. A seal 516 is positioned at the bowl mounting interface 514 to prevent leakage between the reservoir 107 and the secondary collection bowl 504 while allowing the nozzle shaft 508 to pass through without fluid bypass.

As further depicted in FIG. 8, once the fluid 103 reaches the predetermined fill height within the reservoir 107, it flows over the overflow brim 502 and descends into the secondary collection bowl 504. The cross-sectional view illustrates that the overflow brim 502 establishes a wide-surface-area overflow path at the upper edge of the reservoir 107, which minimizes suction forces acting on the polymer forms 111 or 510 and prevents their removal from the treatment zone. The fluid flowing over the overflow brim 502 is captured by the secondary collection bowl 504 and directed toward the discharge path 506, which is shown extending from a lower portion of the secondary collection bowl 504 for removal of treated fluid from the system. The cross-sectional perspective of FIG. 8 further reveals the annular gap between the outer wall of the reservoir 107 and the inner wall of the secondary collection bowl 504, which defines the collection volume for overflow fluid. This arrangement ensures that the treated fluid exits the system in a controlled manner while the rotational motion within the reservoir 107 continues undisturbed. The cross-sectional view of FIG. 8 demonstrates the complete fluid circuit from input through treatment and discharge, confirming the passive, gravity fed or pump fed nature of the dual bowl assembly 500.

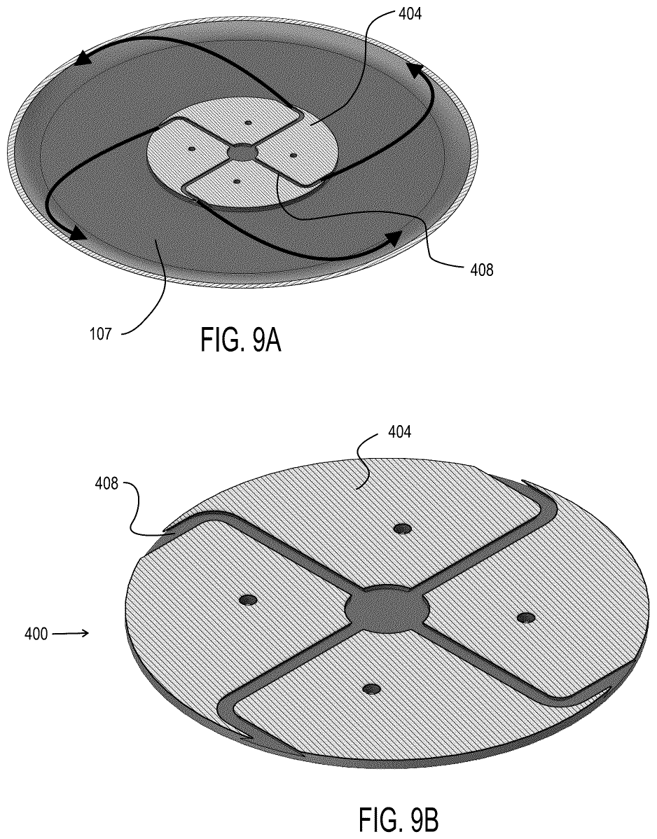

FIGS. 9A and 9B are view of the central-mounted multi-outlet nozzle 400 showing the tangential outlet channel 408 orientation within the nozzle body 404 when positioned within a reservoir 107, as in FIG. 9A, and outside of a reservoir 107, as in FIG. 9B.

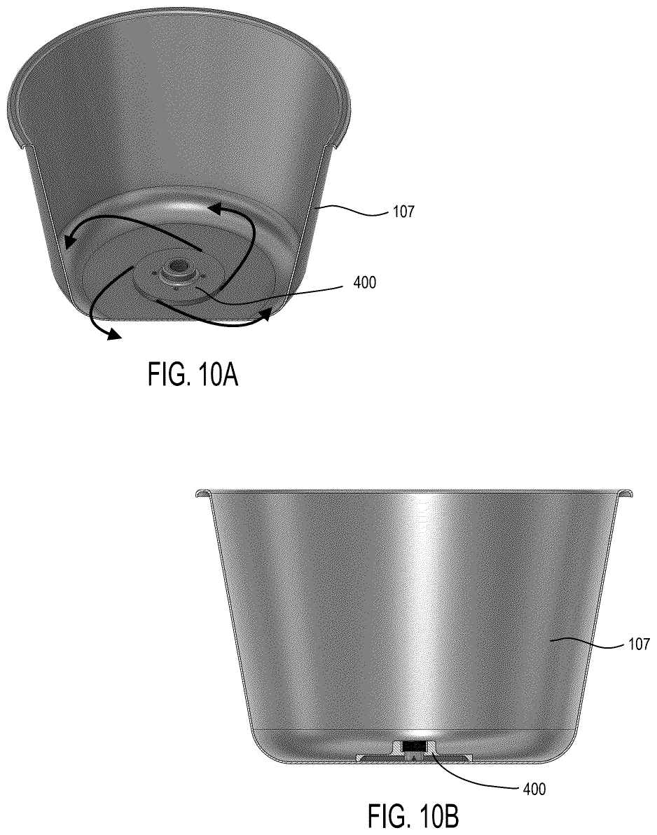

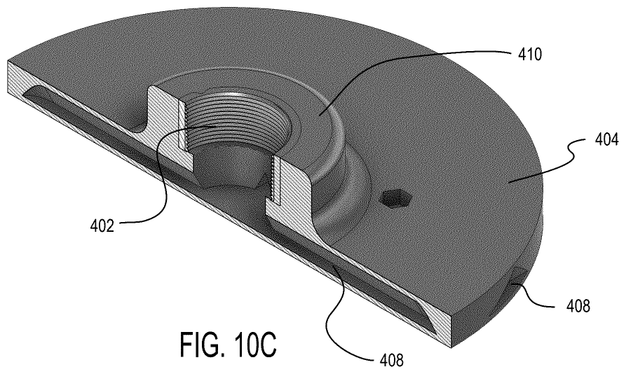

FIGS. 10A and 10B illustrate views of the assembly for providing gravity fed curvilinear motion for polymer release and mixing for the purposes of treating water wherein a central-mounted multi-outlet nozzle 400 is positioned with the reservoir 107.

FIG. 10C is cross-sectional view of the central-mounted multi-outlet nozzle 400 having a nozzle base 410, which provides mechanical engagement with the reservoir floor or a mounting port. The central-mounted multi-outlet nozzle 400 may include and inlet 402 and a nozzle body 404 defining tangential outlet channels 408 therein, the tangential outlet channels 408 being in fluid communication with the inlet 402 and being constructed and arranged around a lower perimeter of the nozzle body 404 and are configured to direct fluid circumferentially along the reservoir interior, thereby inducing rotational motion.

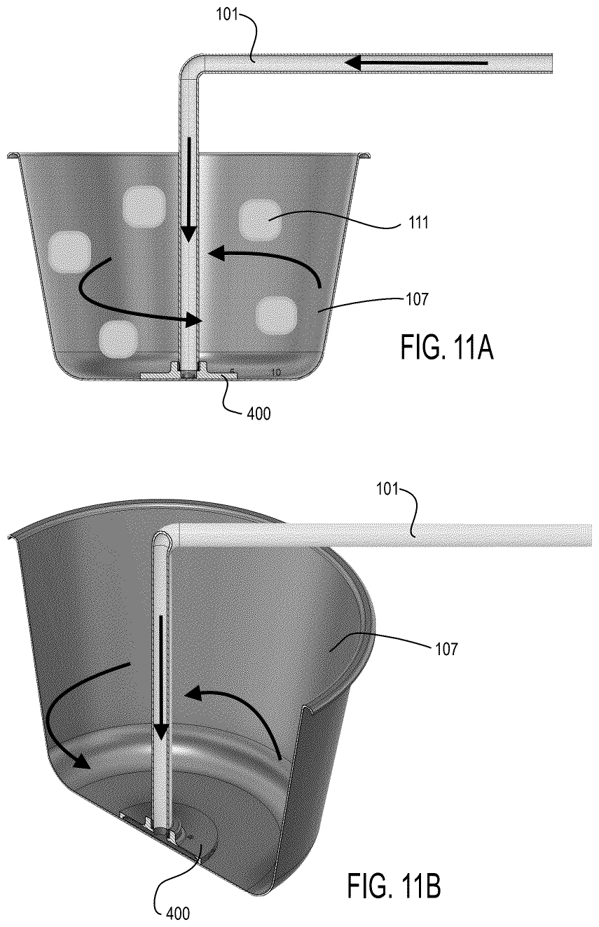

FIGS. 11A and 11B illustrate views of the assembly for providing gravity fed curvilinear motion for polymer release and mixing for the purposes of treating water, including a central-mounted multi-outlet nozzle 400 positioned with the reservoir 107, wherein a fluid input 101 directs the flow of fluid into the central-mounted multi-outlet nozzle 400 via the inlet 402 of FIG. 10C.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure. As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An assembly for providing gravity fed curvilinear motion for polymer release and mixing, comprising:
a reservoir constructed to promote curvilinear motion to a fluid within the reservoir;
a plurality of polymer forms positioned within the reservoir, the plurality of polymer forms composed of a polymer configured to discharge into the fluid responsive to contact with the fluid; and
a central-mounted multi-outlet nozzle positioned within the reservoir, the central-mounted multi-outlet nozzle comprising a hose barb inlet and a plurality of tangential outlet channels arranged around a lower perimeter of the nozzle, each tangential outlet channel oriented to direct fluid circumferentially along an interior wall of the reservoir to induce rotational motion; and
wherein the rotational motion created by the tangential outlet channels increases friction between the fluid and the plurality of polymer forms, thereby increasing the rate of discharge of the polymer into the fluid to result in the treatment of the fluid.

2. The assembly of claim 1, wherein each of the plurality of tangential outlet channels is angled close to tangent relative to a cylindrical wall of the central-mounted multi-outlet nozzle to impart rotational velocity to the fluid.

3. The assembly of claim 1, wherein the central-mounted multi-outlet nozzle is positioned at or near a geometric center of a floor of the reservoir.

4. The assembly of claim 1, wherein the plurality of polymer forms are free floating polymer forms configured to move within the rotational motion created by the central-mounted multi-outlet nozzle.

5. The assembly of claim 1, wherein the plurality of polymer forms are positioned within a container configured to increase exposure time between the polymer and the fluid.

6. A method for treating stormwater using gravity fed curvilinear motion for polymer release and mixing, comprising the steps of:
directing stormwater into a reservoir constructed to promote curvilinear motion of the stormwater;
positioning a plurality of polymer forms within the reservoir such that the curvilinear motion causes disintegration of the plurality of polymer forms into the stormwater;
introducing the stormwater into the reservoir using a nozzle, the nozzle including a plurality outlet channels configured to impart rotational motion to the stormwater;
allowing the stormwater to rise within the reservoir until flowing over an overflow brim positioned at an upper edge of the reservoir;
receiving the overflowed stormwater in a secondary collection bowl positioned below the reservoir; and
wherein the rotational motion produced within the reservoir increases friction between the stormwater and the plurality of polymer forms to improve polymer dissolution.

7. The method of claim 6, wherein the step of introducing stormwater into the reservoir using the nozzle includes dividing the stormwater into multiple smaller jets discharged tangentially around the reservoir interior.

8. The method of claim 6, wherein the step of receiving the overflowed stormwater in the secondary collection bowl includes directing the stormwater toward a discharge pipe positioned below the secondary collection bowl.

9. The method of claim 6, wherein the plurality of polymer forms are allowed to float freely within the reservoir without tethering.

10. The method of claim 6, wherein the rotational motion created by the outlet channels increases collisions between sediment particles and polymer to enhance floc formation.

11. A method for treating stormwater using pump fed curvilinear motion for polymer release and mixing, comprising the steps of:
pumping stormwater into a reservoir;
introducing the pumped stormwater into the reservoir in a manner that induces rotational flow of the stormwater within the reservoir, the rotational flow producing curvilinear motion of the stormwater;
positioning a plurality of polymer forms within the reservoir such that the curvilinear motion causes disintegration of the plurality of polymer forms into the stormwater;
maintaining interaction between the rotating stormwater and the plurality of polymer forms for a residence time sufficient to increase agglomeration of suspended particles within the stormwater; and
discharging stormwater from the reservoir after promoting agglomeration of suspended particles within the stormwater.

12. The method of claim 11, wherein the plurality of polymer forms are free floating polymer forms configured to remain mobile within the rotational flow and to circulate within the reservoir.

13. The method of claim 11, wherein the step of introducing the pumped stormwater into the reservoir comprises directing the stormwater through one or more inlets oriented to direct the stormwater tangentially or circumferentially within the reservoir.

14. The method of claim 11, wherein the step of discharging stormwater from the reservoir comprises allowing the stormwater to overflow an upper edge of the reservoir while retaining the plurality of polymer forms within the reservoir.

15. The method of claim 11, wherein the step of introducing the pumped stormwater into the reservoir comprises directing the stormwater near a lower region of the reservoir to reduce sediment accumulation along a bottom surface of the reservoir.

16. The method of claim 11, wherein the residence time is controlled by adjusting a flow rate of a pump used to pump the stormwater into the reservoir.

17. The method of claim 11, wherein the plurality of polymer forms comprise solid block anionic polyacrylamide.

18. The method of claim 11, wherein the step of discharging stormwater from the reservoir comprises selectively discharging treated stormwater and agglomerated particles while retaining the plurality of polymer forms within the reservoir.

19. The method of claim 11, wherein the rotational flow within the reservoir increases collisions between suspended particles and the plurality of polymer forms to enhance floc formation.

20. The method of claim 11, wherein the reservoir has a conical, frustoconical, cylindrical, rectangular, or polygonal shape.
